(19) United States
(12) Patent Application Publication
(10) Pub. No.: US 2024/0404739 A1
(43) Pub. Date: Dec. 5, 2024

(54) METHOD FOR ADJUSTING A VALVE

(71) Applicant: LIEBHERR-AEROSPACE LINDENBERG GMBH, Lindenberg (DE)

(72) Inventors: Martin DOHRING, Lindenberg (DE); Daniel ZIMMERMANN, Wangen (DE); Gerhard SUTTER, Opfenbach (DE)

(73) Assignee: LIEBHERR-AEROSPACE LINDENBERG GMBH, Lindenberg (DE)

(21) Appl. No.: 18/675,207

(22) Filed: May 28, 2024

(30) Foreign Application Priority Data
May 30, 2023 (DE) 10 2023 114 131.7

(51) Int. Cl. H01F 7/121

(52) U.S. Cl. CPC H01F 7/121

(57) ABSTRACT

The present invention relates to a method for adjusting a valve, in particular a servo valve comprising a first stage and a second stage, comprising the steps of: only partially limiting a range of movement of a valve spool which is configured to open and/or close at least one port of the valve so that the spool is movable; applying the valve with a fluid, and changing a position of a nozzle of the valve relative to a jet divider until the at least one port is completely closed by the movable spool. A method according to the invention is preferably used in the manufacture of an aircraft, preferably airplanes.

### CROSS-REFERENCE TO RELATED APPLICATIONS

The present application claims priority to German Patent Application No. 10 2023 114 131.7, filed May 30, 2023, which is incorporated in its entirety by reference herein.

### BACKGROUND OF THE INVENTION

The present invention relates to a method for adjusting a valve, in particular a servo valve comprising a first stage and a second stage.

When adjusting servo valves, it is known from the prior art to fix or clamp the spool and initially set the first stage of the valve.

This is disadvantageous in that clamping often results in damage to a return spring of the spool. In particular, a ball of the return spring is often torn off.

The object underlying the present invention is therefore that of providing a fast and safe method for adjusting a valve, in particular a servo valve.

### SUMMARY OF THE INVENTION

This object is achieved by means of a method having the features as described herein and/or claimed. A method according to the invention for adjusting a valve, in particular a servo valve having a first stage and a second stage, comprises the following steps:
a) only partially limiting a range of movement of a valve spool, which is configured to open and/or close at least one port of the valve so that the spool is movable;
b) pressurizing the valve with fluid, and
c) changing a position of a nozzle of the valve relative to a jet divider until the at least one port is completely closed by the movable spool.

### BRIEF DESCRIPTION OF THE DRAWINGS

The figures show in:

FIG. 1 a servo valve which is adjustable by means of a method according to the invention;

FIG. 2A a range of movement of the spool in normal operation; and

FIG. 2B a partially limited range of movement of the spool 4 during a method according to the invention.

### DETAILED DESCRIPTION

In accordance with the invention, the spool is thus not completely fixed in step a), but merely restricted in its movement, although a limited movement of the spool remains possible.

In step b), fluid is introduced into the valve and the fluid initially leaves the valve via the at least one port. As the spool has a limited movement, pressure symmetry is established in the preferably two channels downstream of the jet divider as long as the spool does not come to a stop.

In step c), the position of the nozzle is changed, for example, in four (front, rear, right, left) or six (front, rear, right, left, top, bottom) directions until the spool has moved to a zero position, in which it completely closes the at least one port and the flow of fluid from the at least one port stops.

To partially limit the range of movement of the valve spool, at least one limiting element can be used, which limits the range of movement of the spool in relation to the maximum possible deflection of the spool during operation of the valve.

The limiting element can, for example, be positioned in front of a stop of the spool valve in the direction of the spool valve when the valve is in operation. The limiting element can be made of plastic.

The at least one limiting element can be removed from the valve after completion of step c) or after completion of the valve adjustment. During operation of the adjusted valve, the limiting element is thus preferably not present.

A method according to the invention provides the advantage that the method can be used to adjust a first stage and a second stage of a servo valve simultaneously. Since the spool of the second stage remains movable when the valve is adjusted, the position of the spool automatically adapts to changes in the position of the nozzle of the first stage relative to the jet divider. In other words, the adjustment of the first stage is automatically followed by the second stage.

In order to prevent oscillation when the position of the nozzle is changed in step c), the valve can be magnetized before step c). For example, step b) can also include magnetization of the valve.

In order to ensure correct actuation of the armature of the pilot stage of the valve, a method according to the invention may further comprise a step d) of matching at least two air gaps between an armature of the valve and at least one pole piece arranged adjacent to the armature, wherein the matching preferably is carried out in such a way that the at least two air gaps are equal to each other.

For example, four air gaps can be provided (top and bottom and right and left), which are adjusted by positioning the armature and/or the pole pieces so that they are identical.

In a method according to the invention, prior to magnetization of the valve, preferably magnetization in step b), a range of movement of an armature of a first stage of the valve can be at least partially limited, for example by adjusting a bias screw.

One advantage of a method according to the invention is that it can be automated.

One aspect of the invention thus relates to a system with a control unit which is configured to control the system to carry out a method according to the invention.

Such a system may include at least one sensor for measuring fluid flow in at least one port of the valve, and the control unit may be adapted to change a position of a nozzle of the valve relative to a jet divider based on measurement data from the sensor until the at least one port is completely closed by the movable spool.

In a method according to the invention, step c) in particular can thus be automated and the change in the position of the nozzle can be controlled on the basis of pressure measurement values and/or flow measurement values measured in at least one channel downstream of the jet divider.

In principle, step c) can be carried out either manually or automatically.

A further aspect of the present invention relates to a use of a method or apparatus according to the invention for manufacturing an aircraft, in particular an airplane.

At this point, it should be noted that the terms “one” and “one” do not necessarily refer to exactly one of the elements, although this is a possible version, but can also refer to a plurality of the elements. Similarly, the use of the plural also includes the presence of the element in question in the singular and, conversely, the singular also includes several of the elements in question.

Furthermore, all of the features of the invention described herein may be combined with each other or claimed in isolation from each other.

Further details and advantages of the invention are explained in more detail with reference to an exemplary embodiment shown in the drawing.

The present invention can be applied to a two-stage or multi-stage electrohydraulic servo valve.

In today's hydro systems technology, particularly high demands are placed on the operating behavior of the hydraulic components installed within a hydro system. In particular, the installed hydraulics should regulate certain hydraulic volume flows or pressures with high precision in accordance with specified control signals. Valves suitable for this purpose, especially continuous valves, allow a continuous transition of the valve's switching positions.

In continuous valves, an electrical input signal is converted into a hydraulic output signal to control the continuous valve. The servo valves, which have been known for a long time, belong to a category of continuous valves that allow a highly precise and, above all, continuous adjustment of the valve switching position, which is a basic requirement in modern aircraft technology in particular.

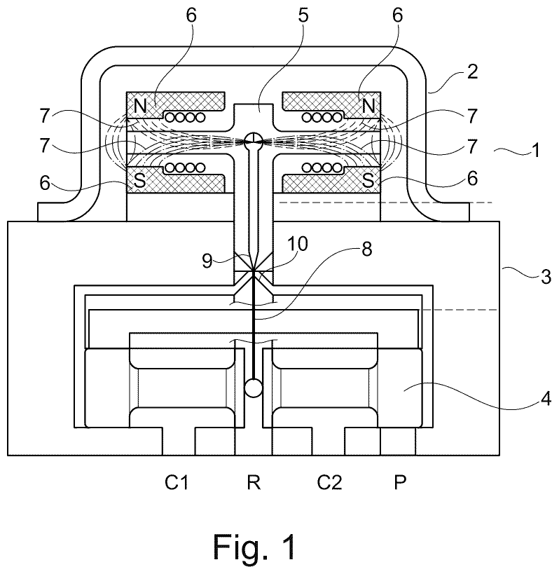

So-called two-stage electro-hydraulic servo valves (EHSV) are known from the prior art, which consist of a first stage, the so-called pilot stage, and a second stage, the so-called power stage. An example of such a valve 1 is shown in FIG. 1. The valve 1 comprises a pilot stage 2 and a power stage 3.

The power stage 3 comprises a control spool 4, which remains in position or is moved depending on the pressures acting on it. The electrically controllable pilot stage 2 comprises an armature 5, which rotates depending on a magnetic field generated by the pole pieces 6 and thereby changes the pressure conditions at the control spool 4, e.g. via a jet-pipe principle.

This causes the control spool 4 to deflect, i.e. the pilot control stage is used to control the power stage, i.e. for a controlled deflection of the control spool, by means of which a volume flow dependent on the position of the control spool, for example through the port P to a component to be controlled, is released or shut off or its size is adjusted. Optionally, the servo valves can also be configured or operate according to the jet-pipe, flapper-nozzle or deflector-jet principle or any other possible operating principle.

In this configuration, there are four air gaps 7 between the armature 5 and the pole pieces 6. A torsion shaft is arranged at the pivot point of armature 5. The control spool 4 is moved via the control pressures. A return spring 8 serves as a coupling element between the control spool 4 and the armature assembly. In a depressurized state or in the event of pressure symmetry, the return spring 8 causes the spool valve 4 to be positioned in the middle position. FIG. 1 also shows the nozzle 9, which can be positioned relative to the jet divider 10.

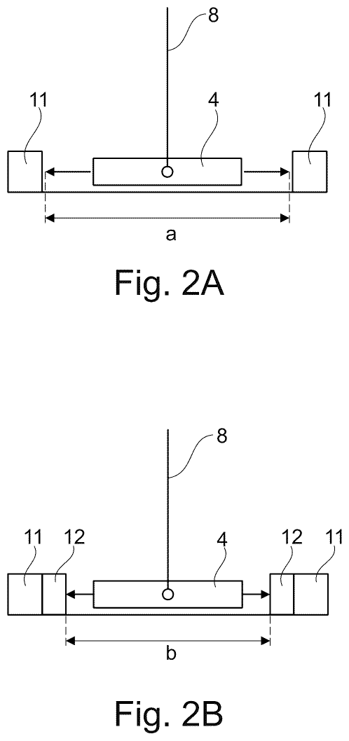

As shown in FIG. 2a, the spool 4 has a range of movement or travel of length “a” between two stops 11 when the valve 1 is in operation.

In a method according to the invention, the range of movement of the spool is temporarily reduced to a length “b” by providing limiting elements 12, which are positioned in front of the stops 11 in the direction of the spool 4. However, the spool 4 remains movable, i.e. the length “b” is not zero, even if it is smaller than the length “a”.

This allows the spool 4 to independently reproduce changes in the positioning of the nozzle 9 relative to the jet divider 10 within its range of movement of length “b”, so that the pilot control stage and the power stage can be adjusted in one work step, i.e. simultaneously.

1. A method for adjusting a valve comprising a first stage and a second stage, said method comprising the steps:
a) only partially limiting a range of movement of a valve spool, which is configured to open and/or close at least one port of the valve so that the spool is movable;
b) applying the valve with a fluid, and
c) changing a position of a nozzle of the valve relative to a jet divider until the at least one port is completely closed by the movable spool.

2. The method according to claim 1, wherein at least one limiting element is used to partially limit the range of movement of the valve spool, which element limits the range of movement of the spool with respect to a maximum deflection of the spool possible during operation of the valve.

3. The method according to claim 2, wherein the at least one limiting element is removed from the valve after completion of step c).

4. The method according to claim 1, wherein the method is used to adjust a first stage and a second stage of a servo valve simultaneously.

5. The method according to claim 1, wherein step b) further comprises magnetizing the valve.

6. The method according to claim 1, said method further comprising the step d) adapting at least two air gaps between an armature of the valve and at least one pole piece arranged adjacent to the armature.

7. The method according to claim 1, wherein before magnetization of the valve, a range of movement of an armature of a first stage of the valve is at least partially limited.

8. The method according to claim 1, wherein step c) is carried out either manually or automatically.

9. The method according to claim 8, wherein step c) is automated and the change in the position of the nozzle is controlled on the basis of pressure readings and/or flow readings measured in at least one channel downstream of the jet divider.

10. A system, which is configured to carry out the method of claim 1, said system comprising: at least one sensor for measuring a fluid flow in at least one port to be opened and/or closed by the spool, and a control unit which is configured to change a position of a nozzle of the valve relative to a jet divider based on measurement data of the at least one sensor until the at least one port is completely closed by the movable spool.

11. A method to manufacture an aircraft, said method comprising utilizing the method of claim 1.

12. The method of claim 1, wherein the valve is a servo valve.

13. The method according to claim 1, said method further comprising the step d) adapting at least two air gaps between an armature of the valve and at least one pole piece arranged adjacent to the armature, wherein the adaptation is carried out in such a way that the at least two air gaps are equal to each other.

14. The method according to claim 1, wherein before magnetization of the valve in step b), a range of movement of an armature of a first stage of the valve is at least partially limited.

15. A method to manufacture an aircraft, said method comprising utilizing the system of claim 10.
